(19) United States
(12) Patent Application Publication
(10) Pub. No.: US 2002/0039885 A1
(43) Pub. Date: Apr. 4, 2002

(54) Split repeater

(76) Inventors: Haim Weissman, Haifa (IL); Eli Yona, Binyamina (IL)

Correspondence Address: QUALCOMM Incorporated, 5775 Morehouse Drive, San Diego, CA, 92121-1714, US

(21) Appl. No.: 10/006,296

(22) Filed: Dec. 6, 2001

Related U.S. Application Data
(63) Continuation of application No. 09/431,434, filed on Nov. 1, 1999, now abandoned.

(51) Int. Cl. H04B 7/14

(52) U.S. Cl. 455/20; 455/11.1

(57) ABSTRACT

Repeater apparatus for conveying a radio-frequency (RF) signal into an environment closed-off to the RF signal, including a master transceiver unit having a master port which receives the RF signal, a local oscillator (LO), which generates a LO signal at a LO frequency, and a frequency divider which divides the LO frequency of the LO signal by an integer to produce a divided LO signal. The master transceiver unit also includes a master mixer coupled to the master port and the divider which generates an intermediate-frequency (IF) signal responsive to the RF signal and the LO signal. The apparatus includes one or more slave transceiver units, each unit positioned within the environment closed-off to the RF signal and including a frequency multiplier which generates a recovered LO signal at the LO frequency by multiplying the frequency of the divided LO signal by the integer, a slave mixer coupled to the multiplier which generates a recovered RF signal responsive to the recovered LO signal and the IF signal, and a slave port coupled to the slave mixer which receives the recovered RF signal therefrom and transmits the recovered RF signal into the closed-off environment. The apparatus further includes one or more cables coupled between the master transceiver unit and the one or more slave transceiver units which convey the IF signal and the divided LO signal between the master transceiver unit and the one or more slave transceiver units.

### RELATED APPLICATIONS

This Application is a continuation of U.S. patent application Ser. No. 09/431,434, filed on Nov. 1, 1999, Attorney Docket No. 990519.

### FIELD OF THE INVENTION

The present invention relates generally to transmission of electromagnetic signals, and specifically to automatic amplification and retransmission of the signals.

### DESCRIPTION OF THE RELATED ART

Electronic repeaters, wherein a received electromagnetic signal is automatically amplified and then retransmitted, are well known in the art. Use of a repeater enables a relatively low-power original signal, such as that from a mobile telephone unit, to be transmitted with a power orders of magnitude greater than the original signal.

FIG. 1 illustrates a repeater system 10, as is known in the art. A first antenna 12 receives a signal from a first transmitter 13, for example a cellular base transceiver station (BTS). The signal is transferred on a coaxial cable 14 to a repeater 16, wherein the signal is amplified and transferred on a coaxial cable 18 to a second antenna 20, which transmits the “repeated” signal generated by repeater 16. Similarly, a signal received by antenna 20 from a second transmitter 15, such as a mobile telephone, traverses a reverse path through system 10, being amplified in repeater 16 and retransmitted by antenna 12. Overall power gains typically required for the signals, from antenna to antenna, are of the order of 90 dB.

Since antennas 12 and 20 are operating on the same frequencies and are both positioned within range of both transmitters, it is important to isolate the antennas one from another in order to avoid interference effects. In order to achieve stability, the antennas need to be isolated by a factor of the order of 110 dB. Typically the antennas are partially isolated by carefully aiming each antenna so that significant radiation from one antenna is not incident on the other antenna, and so that each antenna mainly receives signals from either transmitter 13 or 15, but not both. In practice, sufficient isolation can only be achieved by having the antennas separated by a relatively large physical distance, of the order of at least 30 m. Thus, cable 14 and cable 18 need to be as long as possible.

Lengthening cables 14 and 18 introduces some deleterious effects into system 10. The longer the cables, the higher the noise level of the signals received by repeater 16 from the antennas. To overcome the increased noise, filters are introduced into the repeater. The longer cables also attenuate signals transmitted therein, necessitating increased gain of power amplifiers within the repeater to compensate for the attenuation. At frequencies of the order of 1 GHz, such as those used by cellular telephone systems, leakage of radiation from the cables may be significant, although the leakage is typically limited by using densely-sheathed coaxial cable or even doubly-shielded cable.

Repeaters which separate the functions performed by repeater 16 into two or more separate systems are also known in the art. U.S. Pat. No. 5,404,570, to Charas et al, which is incorporated herein by reference, describes a repeater system used between a base transceiver station (BTS) and a closed environment, such as a tunnel, which is closed off to transmissions from the BTS. The system down-converts a high radio-frequency (RF) signal from the BTS to an intermediate frequency (IF) signal, which is then radiated by a cable and an antenna in the closed environment to a receiver therein. The receiver up-converts the IF signal to the original RF signal. Systems described in the patent serve a vehicle moving in a tunnel, so that passengers in the vehicle who would otherwise be cut off from the BTS are able to receive signals.

U.S. Pat. No. 5,603,080, to Kallandar et al., which is incorporated herein by reference, describes a plurality of repeater systems used between a plurality of BTSs and a closed environment, which is closed off to transmissions from the BTSs. Each repeater system down-converts an RF signal from its respective BTS to an IF signal, which is then transferred by a cable in the closed environment to one or more respective receivers therein. Each receiver up-converts the IF signal to the original RF signal. Systems described by the inventors serve a vehicle moving between overlapping regions in a tunnel, each region covered by one of the BTSs via its repeater system.

U.S. Pat. No. 5,765,099, to Georges et al., which is incorporated herein by reference, describes a system and method for transferring an RF signal between two or more regions using a low-bandwidth medium such as twisted-pair cabling. In a first region the RF signal is mixed with a first local oscillator to produce a down-converted IF signal. The IF signal is transferred to a second region via the low-bandwidth medium, wherein the signal is up-converted to the original RF signal using a second local oscillator. The local oscillators are each locked by a phase locked loop (PLL) in each region to generate the same frequency, the locking being performed in each loop by comparing the local oscillator frequency with a single low-frequency stable reference signal generated in one region. The reference signal is transferred between the regions via the low-bandwidth medium.

### SUMMARY OF THE INVENTION

It is an object of some aspects of the present invention to provide an improved method and apparatus for repeating of electromagnetic signals.

In preferred embodiments of the present invention, a split repeater comprises a master transceiver unit and a slave transceiver unit coupled together by a connecting cable. Each unit is able to receive and transmit radio frequency (RF) electromagnetic signals via a respective antenna. The antennas are preferably positioned in a common environment, i.e., there are substantially no electromagnetic barriers between the antennas, but are independently positionable due to the use of the connecting cable.

Operating the repeater as two separate units connected by a cable gives a number of significant advantages over systems having one unit:

There is more flexibility in positioning the antennas of each of the units.

Each unit may be positioned close to its antenna, improving the noise characteristics of signals received by both antennas.

Because signals are transmitted within the cable at intermediate frequencies, there is less loss in the cable, and less leakage radiation from the cable. Any loss that does incur occur is easily compensated for by intermediate frequency amplification, which does not add significant noise to the original signals.

In some preferred embodiments of the present invention, the connecting cable carries intermediate frequency (IF) signals. The master unit receives a RF signal on its antenna, down-converts the received signal to a forward intermediate frequency (IF-FWD) signal, and transfers the IF-FWD signal by the cable to the slave unit. The IF-FWD signal is up-converted and then transmitted by the antenna of the slave unit. Similarly, a signal received by the slave unit on its antenna is down-converted to a reverse intermediate frequency (IF-REV) signal, which IF-REV signal is transferred via the cable to the master unit. The IF-REV signal is up-converted and transmitted by the master unit antenna. By utilizing intermediate frequencies to transfer the signals, significantly greater isolation between signals received by the master and the slave units can be incorporated into the system. Preferably, in generating the intermediate frequencies, filters are used in both units, which filters may also be adjusted to serve the function of substantially reducing or eliminating unwanted and/or interfering signals received by the master and slave antennas, particularly signals outside a certain communication channel or set of channels that is to be repeated.

In some of these preferred embodiments, the master unit generates a local oscillator (LO) signal which is mixed with the signal from the antenna of the master unit to generate the IF-FWD signal. Most preferably, the local oscillator signal is also used to regenerate an original signal from the IF-REV signal received from the slave unit. Preferably, the frequency of the LO signal is divided by an integer, thus generating a lower-frequency signal. The lower-frequency signal is transmitted on the connecting cable to the slave unit, where its frequency is multiplied by the integer to regenerate the LO signal. In the slave unit, the regenerated LO signal is used both to regenerate the master signal from the IF-FWD signal received from the master unit, and as a local oscillation for producing the IF-REV signal transmitted to the master unit. Alternatively, the LO signal generated by the master unit is transmitted to the slave unit in an undivided form. Using the same LO signal in the two units eliminates in a simple fashion problems caused by having a separate local oscillator in each unit. Furthermore, since the same LO signal is used in both units for up- and down-conversion, there is no need for the local oscillator to be particularly stable, so that phase-locked loops, which are used to stabilize the LO frequency in repeaters known in the art, are not needed.

In other preferred embodiments of the present invention, the master transceiver unit amplifies a master RF signal received on its antenna without down-conversion to an intermediate frequency. The amplified signal is transferred via the connecting cable to the slave transceiver unit, wherein it is further amplified then transmitted from the antenna of the slave unit. Similarly, a RF signal received by the slave unit on its antenna is amplified without down-conversion, then transferred via the cable to the master unit, wherein it is further amplified then transmitted by the master unit antenna.

In some preferred embodiments of the present invention, a power supply located in or near the master unit produces DC voltage to power the master unit. The DC voltage is transferred via the connecting cable to the slave unit, in order to also power the slave unit. Alternatively, the power supply may be located in or near the slave unit to power the slave unit, and DC voltage transferred via the cable to the master unit.

In some preferred embodiments of the present invention, the master unit comprises a remote control unit, whereby control and monitoring of the master and/or slave unit may be performed by an operator remote from one or both of the units. Most preferably, the remote control unit operates by transmitting signals between the master unit and the remote operator.

In some preferred embodiments of the present invention, operation of the slave unit is controlled from the master unit, via a modulated signal such as an FSK signal, transmitted from the master unit to the slave unit.

There is therefore provided, in accordance with a preferred embodiment of the present invention, a radio-frequency (RF) repeater, including:

a master antenna, positioned to receive an RF master signal;

a master unit, including:

a master RF port, coupled to receive the RF master signal from the master antenna;

a local oscillator, which generates a master local oscillator signal at a local oscillation frequency; and

a master mixer which mixes the RF master signal and the master local oscillator signal to generate an intermediate frequency (IF) signal;

a cable which is coupled to the master unit so as to receive therefrom the IF signal and a reference signal at a reference frequency, derived from the local oscillator signal;

a slave antenna, positioned in a common environment with the master antenna; and

a slave unit, coupled to receive the IF signal and the reference signal from the cable, the slave unit including:

a slave mixer which mixes the IF signal and a slave local oscillator signal at the local oscillation frequency, derived from the reference signal, so as to recover the received RF master signal; and

a slave RF port, which is coupled to convey the recovered RF master signal to the slave antenna for transmission thereby.

Preferably, the master port is a two-way port, and the slave RF port is a two-way port through which the slave unit receives an RF slave signal from the slave antenna and downconverts the RF slave signal by mixing it with the slave local oscillator signal to produce a slave IF signal which is conveyed by the cable to the master unit, wherein the slave RF signal is recovered and is conveyed by the master port to the master antenna for transmission thereby.

Preferably, the reference frequency is substantially less than the local oscillator frequency.

Preferably, the master unit includes a frequency divider which divides the local oscillation frequency by an integer to derive the reference frequency, and the slave unit includes a frequency multiplier which multiplies the reference frequency by the integer to regenerate the local oscillation frequency.

Alternatively, the master unit includes a DC power supply which generates a DC level that is conveyed by the cable to power the slave unit.

Preferably, the repeater includes a controller in one of the slave or master units which controls the operation of both units.

Preferably, the repeater includes a remote control unit which transfers control signals between the controller and an operator of the repeater.

Alternatively, the controller generates modulated control signals which are conveyed by the cable between the master and the slave units.

Preferably, the repeater operates in a communications network at frequencies in the range 450 MHz to 30 GHz.

Alternatively, the repeater operates in a cellular communications network at frequencies in the range 800 MHz to 1900 MHz.

Preferably, the frequency of the IF signal is substantially less than the frequency of the RF signal.

Preferably, the frequency of the IF signal is substantially less than the local oscillation frequency.

Preferably, the IF signal corresponds to one or more predetermined channels of a multiple access communications network.

There is further provided, in accordance with a preferred embodiment of the present invention, a radio-frequency (RF) repeater, including:

a master unit, including:

a master RF port, coupled to receive an RF signal from a master antenna;

a local oscillator, which generates a master local oscillator signal at a local oscillation frequency; and

a master mixer which mixes the RF signal and the master local oscillator signal to generate an intermediate frequency (IF) signal;

a cable which is coupled to the master unit so as to receive therefrom the IF signal and a reference signal at a reference frequency substantially less than the local oscillation frequency, which reference signal is derived from the local oscillator signal; and

a slave unit, coupled to receive the IF signal and the reference signal from the cable, the slave unit including:

a slave mixer which mixes the IF signal and a slave local oscillator signal at the local oscillation frequency, derived from the reference signal, so as to recover the received RF signal; and

a slave RF port, which is coupled to convey the recovered RF signal to a slave antenna.

Preferably, the master port is a two-way port, and the slave port is a two-way port through which the slave unit receives an RF slave signal from the slave antenna and downconverts the RF slave signal by mixing it with the slave local oscillator signal to produce a slave IF signal which is conveyed by the cable to the master unit, wherein the slave RF signal is recovered and is conveyed by the master port to the master antenna for transmission thereby.

Preferably, the master unit includes a frequency divider which divides the local oscillation frequency by an integer to derive the reference frequency, and the slave unit includes a frequency multiplier which multiplies the reference frequency by the integer to regenerate the local oscillation frequency.

Alternatively, the master unit includes a DC power supply which generates a DC level which is conveyed by the cable to power the slave unit.

Preferably, the repeater includes a controller in one of the slave or master units which controls the operation of both units.

Preferably, the IF signal corresponds to one or more predetermined channels of a multiple access communications network.

There is further provided, in accordance with a preferred embodiment of the present invention, a method for repeating a radio-frequency (RF) signal, including:

receiving the RF signal from a first antenna at a first location;

generating at the first location a first local oscillator signal having a local oscillation frequency;

mixing the RF signal with the first local oscillator signal at the first location to produce an intermediate frequency (IF) signal;

deriving a reference signal having a reference frequency from the first local oscillator signal at the first location;

transferring the IF and reference signals over a cable to a second location in a common environment with the first location;

processing the reference signal at the second location to reconstruct the local oscillator signal at the local oscillation frequency;

mixing the IF signal and the local oscillator signal at the second location to recover the RF signal; and

transferring the recovered RF signal to a second antenna at the second location for transmission of the signal thereby.

Preferably, the method includes:

receiving a slave RF signal at the second antenna;

mixing the slave RF signal and the local oscillator signal at the second location to produce a slave IF signal;

transferring the slave IF signal over the cable to the first location;

recovering the slave RF signal by mixing the slave IF signal with the first local oscillator signal; and

transmitting the slave RF signal from the first antenna.

Preferably, deriving the reference signal includes dividing the local oscillation frequency by an integer, and processing the reference signal includes multiplying the reference signal frequency by the integer to regenerate the local oscillation frequency.

Preferably, the reference frequency is substantially less than the local oscillator frequency.

Preferably, transferring the IF and reference signals over the cable includes transferring a DC level over the cable.

Preferably, the method includes providing a controller in one of the slave or master units which controls the operation of both units.

Alternatively, the method includes providing a remote control unit which transfers control signals between the controller and an operator of the repeater.

Preferably, the method includes generating modulated control signals at the control unit and conveying the modulated control signals over the cable between the master and the slave units.

Preferably, receiving the RF signal includes receiving a communications transmission at a frequency in the range 450 MHz to 30 GHz.

Alternatively, receiving the RF signal includes receiving a cellular communications transmission at a frequency in the range 800 MHz to 1900 MHz.

Preferably, mixing the RF signal to produce the IF signal includes producing an IF signal having a frequency substantially less than the frequency of the RF signal.

Preferably, mixing the RF signal to produce the IF signal includes producing an IF signal having a frequency substantially less than the local oscillation frequency.

Preferably, mixing the RF signal includes producing the IF signal to correspond to one or more predetermined channels of a multiple access communications network.

There is further provided, in accordance with a preferred embodiment of the present invention, a method for repeating a radio-frequency (RF) signal, including:

receiving the RF signal from a first antenna at a first location;

generating at the first location a first local oscillator signal having a local oscillation frequency;

mixing the RF signal with the first local oscillator signal at the first location to produce an intermediate frequency (IF) signal;

deriving a reference signal having a reference frequency substantially less than the local oscillation frequency, which reference signal is derived from the first local oscillator signal at the first location;

transferring the IF and reference signals over a cable to a second location in a common environment with the first location;

processing the reference signal at the second location to generate a second local oscillator signal at the local oscillation frequency;

mixing the IF signal and the second local oscillator signal at the second location to recover the RF signal; and

transferring the recovered RF signal to a second antenna for transmission of the signal thereby.

Preferably, the method includes:

receiving a slave RF signal at the second antenna;

mixing the slave RF signal and the second local oscillator signal at the second location to produce a slave IF signal;

transferring the slave IF signal over the cable to the first location;

recovering the slave RF signal by mixing the slave IF signal with the first local oscillator signal; and

transmitting the slave RF signal from the first antenna.

Preferably, deriving the reference signal includes dividing the local oscillation frequency by an integer, and processing the reference signal includes multiplying the reference signal frequency by the integer to regenerate the local oscillation frequency.

Preferably, transferring the IF and reference signals over the cable includes transferring a DC level over the cable.

Preferably, mixing the RF signal to produce the IF signal includes producing an IF signal corresponding to one or more predetermined channels of a multiple access communications network.

There is further provided, in accordance with a preferred embodiment of the present invention, a radio-frequency (RF) repeater, including:

a master unit, including:

a master RF port, coupled to receive an RF signal from a master antenna; and

at least one amplifier which generates a first amplified RF signal responsive to the RF signal;

a cable which is coupled to the master unit so as to receive therefrom the first amplified RF signal; and

a slave unit, coupled to receive the first amplified RF signal from the cable, the slave unit including:

at least one amplifier which generates a second amplified RF signal responsive to the RF signal; and

a slave RF port, which is coupled to convey the second amplified RF signal to a slave antenna.

Preferably, the master port is a two-way port, and the slave port is a two-way port through which the slave unit receives an RF slave signal from the slave antenna and amplifies the RF slave signal to produce a first amplified slave IF signal which is conveyed by the cable to the master unit, wherein the first amplified slave RF signal is amplified and is conveyed by the master port to the master antenna for transmission thereby.

Preferably, the first amplified RF signal has an RF frequency substantially equal to the frequency of the RF signal received by the master RF port.

Preferably, the master and slave units are independently positionable in locations that are physically separated from one another.

There is further provided, in accordance with a preferred embodiment of the present invention, a method for repeating a radio-frequency (RF) signal, including:

receiving the RF signal from a first antenna at a first location;

amplifying the RF signal at the first location to produce a first amplified RF signal;

transferring the first amplified RF signal over a cable to a second location;

amplifying the first amplified RF signal at the second location to produce a second amplified RF signal;

transferring the second amplified RF signal to a second antenna at the second location for transmission of the signal thereby.

Preferably, the method includes:

receiving a slave RF signal at the second antenna;

amplifying the slave RF signal at the second location to produce a first amplified slave RF signal;

transferring the first amplified slave RF signal over the cable to the first location;

amplifying the first amplified slave RF signal at the first location to produce a second amplified slave RF signal; and

transmitting the second amplified slave RF signal from the first antenna.

Preferably, the first location is physically separated from the second location.

Preferably, the first amplified RF signal has a RF frequency substantially equal to the frequency of the RF signal received from the first antenna.

The present invention will be more fully understood from the following detailed description of the preferred embodiments thereof, taken together with the drawings, in which:

### BRIEF DESCRIPTION OF THE DRAWINGS

FIG. 1 schematically illustrates a repeater system, as is known in the art;

FIG. 2 schematically illustrates a split repeater system, according to a preferred embodiment of the present invention;

FIG. 3 is a schematic block diagram of a master unit in the split repeater system illustrated in FIG. 2, according to a preferred embodiment of the present invention;

FIG. 4 is a schematic block diagram of a slave unit in the split repeater system illustrated in FIG. 2, according to a preferred embodiment of the present invention;

FIGS. 5A and 5B are schematic frequency diagrams showing frequency bands used by the split repeater system illustrated in FIG. 2, according to a preferred embodiment of the present invention;

FIG. 6 schematically illustrates a split repeater system, according to an alternative preferred embodiment of the present invention;

FIG. 7 is a schematic block diagram of a master unit in the split repeater system illustrated in FIG. 6, according to a preferred embodiment of the present invention; and

FIG. 8 is a schematic block diagram of a slave unit in the split repeater system illustrated in FIG. 6, according to a preferred embodiment of the present invention.

### DETAILED DESCRIPTION OF THE INVENTION

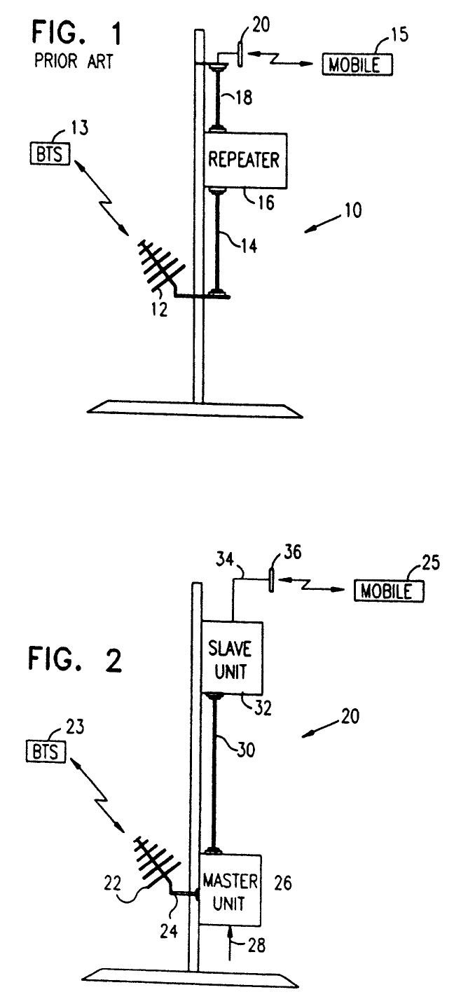

Reference is now made to FIG. 2, which schematically illustrates a split repeater system 20, according to a preferred embodiment of the present invention. A master antenna 22 receives a master electromagnetic radio-frequency (RF) signal from a first remote transmitter 23. Transmitter 23 is preferably a transmitter comprised in a base transceiver station (BTS) of a cellular telephone system, although any other suitable transmitter could also be used. The master RF signal is transferred from antenna 22 to a master unit 26 in substantially the same location as the antenna via an RF-signal conductor 24. Most preferably, the length of conductor 24 is as short as possible, so that noise introduced by the conductor is as small as possible, and so that radiation from the conductor is also as small as possible. Most preferably, conductor 24 comprises a standard coaxial cable having one or more dense sheathings and/or a low-loss dielectric in order to reduce radiation from and attenuation in the cable, as are known in the art.

Master unit 26 receives the master RF signal from conductor 24 and down-converts the signal to a forward intermediate frequency (IF-FWD) signal, so that master unit 26 functions as a frequency conversion unit. The IF-FWD signal is transferred via a cable 30 to a slave unit 32, wherein the IF-FWD signal is up-converted to a “repeated” master RF signal corresponding to the RF signal received by master unit 26. Cable 30 is preferably a standard coaxial cable, although any other cable capable of transferring signals generated within master unit 26 and slave unit 32 may be used. Slave unit 32 thus also functions as a frequency conversion unit. The up-converted RF signal is transferred via a conductor 34, the conductor most preferably having similar characteristics to those described above for conductor 24, to a slave antenna 36 in substantially the same location as the slave unit, which antenna radiates the repeated master RF signal.

Antenna 36 also receives a slave RF signal from a second transmitter 25. Transmitter 25 preferably comprises a transmitter of a cellular telephone, although any other suitable transmitter could be used. Slave unit 32 down-converts the slave RF signal to a reverse intermediate frequency (IF-REV) signal. The IF-REV signal is transferred via cable 30 to master unit 26, wherein the IF-REV signal is up-converted to a repeated slave RF signal. The up-converted slave RF signal is transferred via conductor 24 to master antenna 22, which radiates the repeated slave RF signal.

In installing system 20, antenna 36 and antenna 22 are placed in relatively close physical proximity, so that the signal level from either of remote transmitters 23 or 25 is substantially similar at the position of both of the antennas. However, the system has sufficient flexibility so that the antennas and their associated units can be positioned and oriented such that even with antenna-antenna gains of the order of 90 dB, isolation of 110 dB or better between the antennas is easily achievable. The operations of unit 26 and of unit 32 are explained in detail hereinbelow.

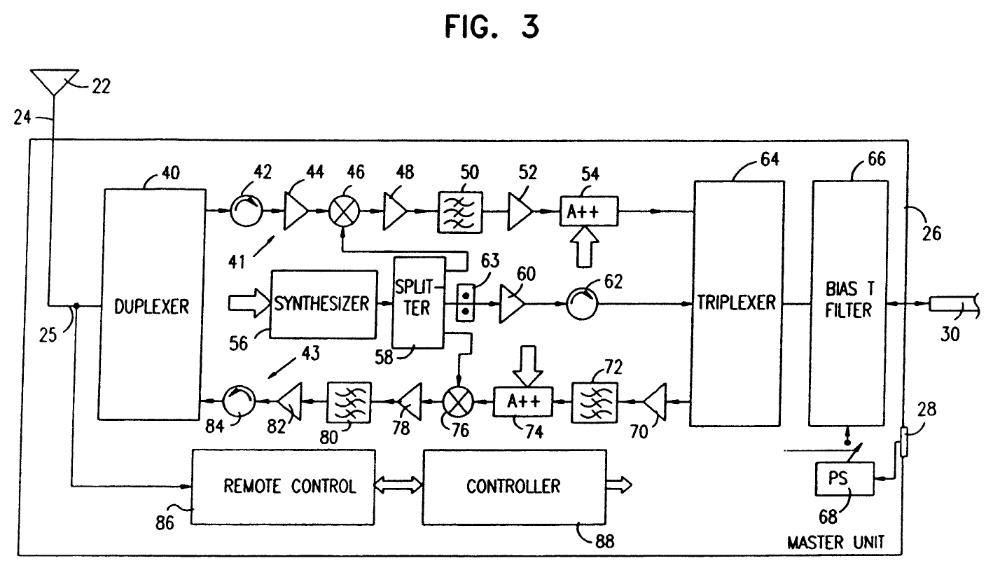

FIG. 3 is a schematic block diagram of master unit 26, according to a preferred embodiment of the present invention. An RF duplexer 40 receives the master RF signal from antenna 22 via conductor 24. Duplexer 40 acts as a port and separates a path 41 of the master signal from a path 43 of the received slave signal, by methods which are known in the art. The master RF signal is transferred, via an isolator 42 which prevents RF radiation back to duplexer 40, to a low noise RF amplifier 44. Amplifier 44 acts as a first stage of amplification in path 41, and is most preferably constructed from very-low-noise components, as are known in the art.

The amplified signal from amplifier 44 is input to a mixer 46. Mixer 46 also receives a local oscillator signal, most preferably generated by a local oscillator frequency synthesizer 56, via a splitter 58. Preferably, a controller 88 sets the frequency generated by synthesizer 56. Mixer 46 uses the local oscillator signal to generate mixed signals comprising intermediate frequency (IF) side-bands, which mixed signals are amplified in a second-stage amplifier 48. The amplified mixed signals are then filtered in a band-pass filter 50 which passes one intermediate frequency band centered on a frequency herein termed IF-FWD, and rejects other bands generated in mixer 46. Preferable choices for the local oscillator frequency, and the corresponding IF-FWD frequency, are described in detail below.

The output of filter 50 is input to a final-stage amplifier 52 and attenuator 54, which together adjust a level of the IF-FWD signal to a value suitable for reception by unit 32, and which supply the adjusted signal to a triplexer 64. Preferably, attenuator 54 is a digital attenuator whose attenuation is set by controller 88.

Preferably, synthesizer 56 also supplies a local oscillator signal via splitter 58 to a frequency divider 63, which divider is set to divide the frequency by an integer, which is typically in the range 2-16, although any other suitable value could be used. The divided local oscillator signal is input to an amplifier 60. Alternatively, the local oscillator signal from splitter 58 is not divided, but is transferred directly to amplifier 60. Amplifier 60 amplifies the received signal and transfers its output as a reference signal operating at a reference frequency to triplexer 64 via an isolator 62, which isolator prevents intermediate frequency signals from triplexer 64 from leaking back to synthesizer 56. Triplexer 64 combines the amplified local oscillator reference signal and the adjusted IF-FWD signal, and transfers the combined signal to a bias-T filter 66.

Filter 66 acts as a port and as a low-pass filter which biases the combined signal from triplexer 64 with a DC level generated by a power supply 68. The DC level generated by supply 68 drives master unit 26. Preferably, power supply 68 receives its driving power in the form of standard AC line power via a connector 28. Alternatively, power supply 68 receives its driving power in any other suitable standard form, such as from a battery. Filter 66 transfers the combined signal at the DC bias level to cable 30, which thus transmits the signal and the DC power to slave unit 32.

Master unit 26 receives the IF-REV signal generated in slave unit 32 in filter 66, via cable 30. The filter separates the signal from the DC level present in the cable. The AC component, i.e., the IF-REV signal, is transferred to triplexer 64. Triplexer 64 directs the IF-REV signal along path 43 of unit 26, to a first amplifier 70 and then to a band-pass filter 72. The filtered amplified signal is then attenuated in an attenuator 74, which attenuator is preferably a digital attenuator whose attenuation is controlled by controller 88. Amplifier 70, filter 72, and attenuator 74 function so that attenuator 74 provides an output level to a mixer 76 according to an overall required repeater gain. Mixer 76 also receives the local oscillator signal from splitter 58, and uses the two signals to regenerate the slave signal received by antenna 36 of slave unit 32.

The regenerated signal is passed along path 43 via a first amplifier 78 and a band-pass filter 80, which together act to produce a preamplified low noise input for a power amplifier 82. Amplifier 82 supplies a final output RF signal, corresponding to the input slave signal, via an isolator 84 and duplexer 40, to antenna 22, which then radiates the amplified slave signal. Most preferably, gains and attenuations of elements of master unit 26 described hereinabove are adjusted so that the overall signal gain, from port to port, for path 41 and for path 43 is of the order of 10-60 dB for each path.

Optionally, master unit 26 comprises a remote control unit 86, such as an “Amber” unit supplied by Qualcomm Inc. of San Diego, Calif., which unit supplies control commands to controller 88. Remote control unit 86 preferably receives signals from an operator via a tap 25 on conductor 24, so that operation of remote control unit 86 is generally independent of other elements comprised in master unit 26. Remote control unit 86 is preferably able to monitor parameters such as the levels set by controller 88 to attenuators 54 and 74, and forward and reverse receive and transmit gains, as well as the frequency generated by synthesizer 56, and transmit values of the monitored parameters to the operator. Preferably, controller 88 operates unit 26 automatically according to instructions which are installed in the controller when unit 26 is initially set up. Most preferably, if remote control unit 86 is installed in unit 26, the instructions operating controller 88 can be changed via the remote control unit.

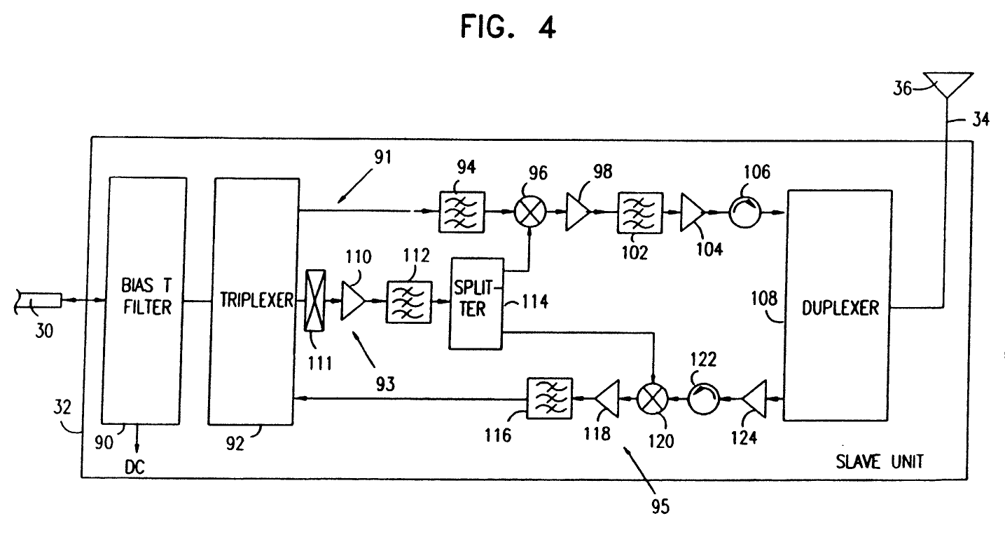

FIG. 4 is a schematic block diagram of slave unit 32, according to a preferred embodiment of the present invention. Slave unit 32 comprises a bias-T filter 90, which receives the IF-FWD signal, the local oscillator reference signal, and the DC level from cable 30. Filter 90 acts as a port, splitting off the DC level to power slave unit 32, and transferring the AC signals to a triplexer 92. Triplexer 92 separates the AC signals into a path 91 followed by the IF-FWD signal, and a path 93 followed by the local oscillator signal.

Preferably, path 93 comprises a frequency multiplier 111, which multiplies the frequency of the divided local oscillator signal by the same integer value used by divider 63 of master unit 30. Thus a local oscillator signal is reconstituted in slave unit 32, which signal has a frequency identical to that of the local oscillator signal originally synthesized by synthesizer 56 of master unit 26, and which is input to an amplifier 110. Alternatively, if the local oscillator signal has not been divided in master unit 30, path 93 does not comprise frequency multiplier 111, and the local oscillator signal from triplexer 92 is input directly to amplifier 110 as a reconstituted signal. The reconstituted local oscillator signal is amplified in amplifier 110, and passed through a band-pass filter 112 to a splitter 114. Amplifier 110 and filter 112 together generate a local oscillator signal level which is suitable for use by a mixer 96 and a mixer 120, which receive the local oscillator signal from splitter 114.

Path 91 comprises a band-pass filter 94, which passes frequencies centered on IF-FWD to mixer 96, and rejects other frequencies. Mixer 96 up-converts the IF-FWD signal received from filter 94, using the reconstituted local oscillator signal, to regenerate the master RF signal received by master unit 26. The up-converted RF signal is amplified in an RF pre-amplifier 98 and filtered in band-pass filter 102, which together prepare an RF signal at a level suitable for inputting to an RF power amplifier 104. Power amplifier 104 generates an RF power output signal corresponding to the original master signal received by the master unit, which power signal is transferred via an isolator 106 to increase the voltage standing wave ratio. The power signal is input to an RF duplexer 108 which acts as a port. Duplexer 108 routes the power signal via signal conductor 34 to slave antenna 36, which radiates the RF power signal.

As explained above, antenna 36 also receives a slave RF signal. The slave signal is routed via RF duplexer 108 along a path 95 to a low noise pre-amplifier 124, which pre-amplifier is most preferably constructed from very-low-noise components by methods known in the art. An isolator 122 substantially eliminates any leakage of the reconstituted local oscillator signal to antenna 36. A mixer 120 uses the reconstituted local oscillator signal received from splitter 114 and the output signal of pre-amplifier 124 to down-convert the slave RF signal to the intermediate frequency signal IF-REV. The IF-REV signal is amplified by an amplifier 118 feeding a band-pass filter 116, which together operate to generate an IF-REV signal substantially free from unwanted sidebands, such as those produced in mixer 120, and having a level suitable for transmission in cable 30. The IF-REV signal output of filter 116 is routed by triplexer 92 and filter 90 to cable 30, wherein it is transmitted to master unit 26.

Preferably, parameters affecting the operation of slave unit 32, such as gains of amplifiers 98, 104, 110, 118, and 124, are preset when slave unit 32 is set up, so that slave unit 32 is able to operate independently. Most preferably, the overall signal gain, from port to port, for path 91 and for path 95 is set to be of the order of 10-60 dB for each path. In a preferred embodiment of the present invention, controller 88 of master unit 26 is able to control and/or monitor the operation of slave unit 32, by transferring control signals to the slave unit on cable 30. Most preferably, the control signals are in the form of a frequency and/or a phase and/or an amplitude modulated signal, such as a frequency shift key (FSK) signal, as are known in the art.

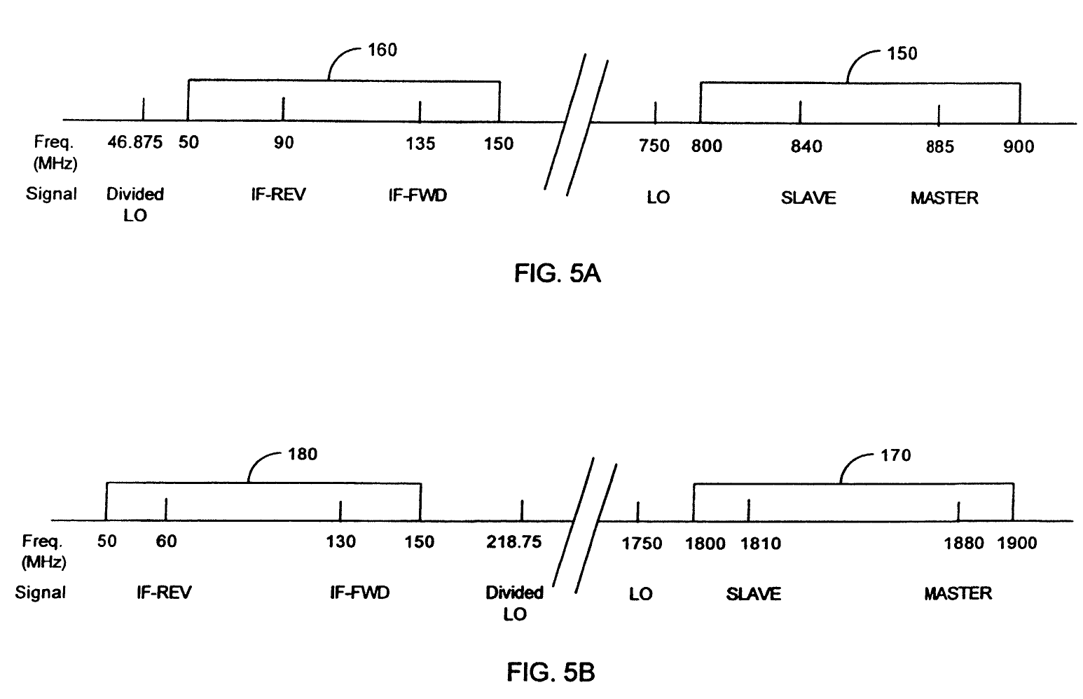

FIGS. 5A and 5B are schematic frequency diagrams showing frequency bands used by system 20, and examples of specific frequencies transmitted within the system, according to a preferred embodiment of the present invention. FIG. 5A shows frequencies used when system 20 operates as a repeater of signals in a frequency band 150 from approximately 800 MHz to 900 MHz. Such a band covers frequencies used by cellular telephone systems, wherein the forward and reverse signals are typically separated by a duplex separation of 45 MHz. In the example shown in FIG. 5A, the master signal received by master antenna 22 has a frequency of 885 MHz and the slave signal received by slave antenna 36 has a frequency of 840 MHz.

Local oscillator synthesizer 56 most preferably generates a local oscillator signal having a frequency below the lowest frequency of band 150, for example, at 750 MHz. With a local oscillator frequency of 750 MHz, intermediate frequencies in a frequency band 160 from approximately 50 MHz to 150 MHz are generated by the master and slave units. The frequency of the IF-FWD signal generated by mixer 46 from the master signal frequency of 885 MHz is 135 MHz. The frequency of the IF-REV signal generated by mixer 120 from the slave signal at 840 MHz is 90 MHz. Divider 63 in master unit 26 preferably divides the local oscillator frequency by an integer, for example 16, giving a divided LO frequency of 46.875 MHz. Thus, frequencies transmitted on cable 30 for the example values given above are 46.875 MHz, 90 MHz, and 135 MHz. Alternatively, if divider 63 does not operate in master unit 26, frequencies transmitted on cable 30 for the typical frequency values given above are 750 MHz, 90 MHz, and 135 MHz.

FIG. 5B shows frequencies used when system 20 operates as a repeater of signals in a frequency band 170 from approximately 1800 MHz to 1900 MHz. Such a band covers frequencies used by personal communication systems (PCS) and/or cellular phones, wherein the forward and reverse signal frequencies are typically separated by a duplex separation of 70 MHz. In the example shown here, the master signal received by master antenna 22 has a frequency of 1880 MH, and the slave signal received by slave antenna 36 has a frequency of 1810 MHz. As described hereinabove, synthesizer 56 most preferably generates a local oscillator signal having a frequency below the lowest value of band 170, for example, at 1750 MHz, thereby generating IF signals in a frequency band 180 from approximately 50 MHz to 150 MHz. The frequency of the IF-FWD signal generated by mixer 46 from the master signal frequency of 1880 MHz is 130 MHz. The frequency of the IF-REV signal generated by mixer 120 from the slave signal of 1810 MHz is 60 MHz. Assuming divider 63 divides the frequency by an integer 8, for example, a divided LO frequency of 218.75 MHz is generated. Thus, frequencies transmitted on cable 30 for the example values given above are 60 MHz, 130 MHz, and 218.75 MHz. Alternatively, if divider 63 does not operate in master unit 26, frequencies transmitted on cable 30 for the example values given above are 60 MHz, 130 MHz, and 1750 MHz.

The frequency separation of the duplex channels, (45 MHz and 70 MHz in the examples described with reference to FIGS. 5A and 5B) remains the same during the down- and up-conversion stages. However, the ratio of the separation to the mean carrier frequency is significantly increased in the IF stages generated in the master and slave units. In the example described above with reference to FIG. 5A, where the mean radio frequency is 850 MHz and the mean intermediate frequency is 100 MHz, the ratio increases from 45/850 to 45/100. It will be appreciated that the increase in ratio enables significantly improved isolation of the duplex channels to be incorporated into the IF stages, by using standard bandpass design of at least some of filters 50, 72, 80, 94, 102, and 116, with no deleterious effect on the stages.

Those skilled in the art will be able to determine other values of frequencies to be generated by system 20 and transmitted on cable 30, for master and slave signals with frequencies other than those of the examples described above with reference to FIGS. 5A and 5B.

Each of the intermediate frequency signals transmitted on cable 30 has a frequency substantially below the frequencies of the master and slave signals received by system 20. The lower frequencies used, and the high levels introduced by the signal amplification in both the master and the slave unit, mean that there is practically no limitation on the length of cable 30. Similar reasoning applies when the local oscillator signal is divided and then transmitted in cable 30. When the local oscillator signal is not divided, it may be necessary to increase the signal levels of the local oscillator to compensate for attenuation in cable 30. Thus, slave unit 32 and its associated antenna 36 may be positioned at substantially any desired distance from master unit 26 and its antenna 22, enabling high gains to be utilized in one or both units without introducing interference in either unit.

In some preferred embodiments of the present invention, some of filters 50, 72, 80, 94, 102, and 116 and/or some of attenuators 54 and 74 are adjusted so that in addition to operating as described hereinabove, unwanted and/or interfering signals received by antenna 22 and antenna 36 are substantially reduced or eliminated. For example, when repeater system 20 is used as a repeater of multiple access signals in a cellular communication network, such as code division multiple access (CDMA) signals, which signals are transmitted in specific channels, the filters and/or attenuators may be adjusted to allow only signals in predetermined channels to be repeated.

While the preferred embodiments described hereinabove utilize frequency bands corresponding to those used by cellular telephone systems, those skilled in the art will be able to apply the principles described above, wherein a radio-frequency signal is down-converted then up-converted to recover the signal, and wherein a single local oscillator signal is utilized in both conversions, to other frequency bands used in communications systems, for instance, bands from approximately 450 MHz to 30 GHz.

By using a single local oscillator in system 20, and transferring the local oscillation signal either directly throughout the system, or by dividing and then multiplying the frequency by an integer, problems such as differences in local oscillator frequencies within a repeater system are eliminated. Thus, it will be appreciated that the single local oscillator does not need to be a high-stability oscillator, such as a crystal-controlled and/or temperature-stabilized oscillator. Since drift in the frequency of oscillation will be transferred throughout the repeater system, there are virtually no special stability requirements for the local oscillator.

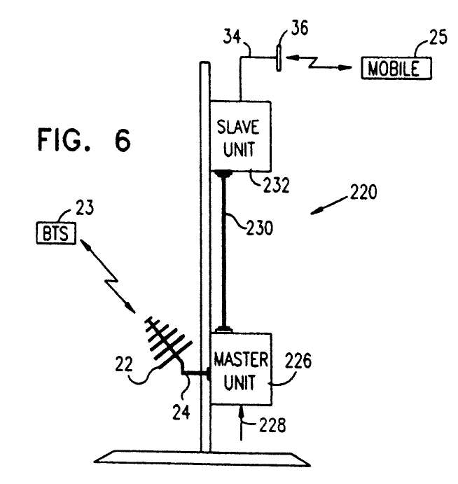

FIG. 6 schematically illustrates a split repeater system 220, according to an alternative preferred embodiment of the present invention. Except where otherwise stated hereinbelow, the operation of system 220 is generally similar to that of system 20, whereby elements indicated by the same reference numerals in systems 20 and 220 are generally identical in operation and construction. System 220 comprises a master unit 226, which is connected to and separated from a slave unit 232 by an RF coaxial cable 230. Master unit 226 receives a master RF signal from antenna 22, and amplifies and transmits the amplified RF signal to cable 230, without down-converting the RF signal to a lower frequency, as described in more detail below. Cable 230 transfers the amplified RF signal to slave unit 232, which further amplifies the signal and transmits the repeated amplified master RF signal from antenna 36. Similarly, as described in more detail below, slave unit 232 receives a slave RF signal from antenna 36, and the slave RF signal is amplified without down-conversion. The amplified slave RF signal is then transferred by cable 230 to master unit 226, where it is further amplified and the amplified repeated slave RF signal is transmitted from antenna 22.

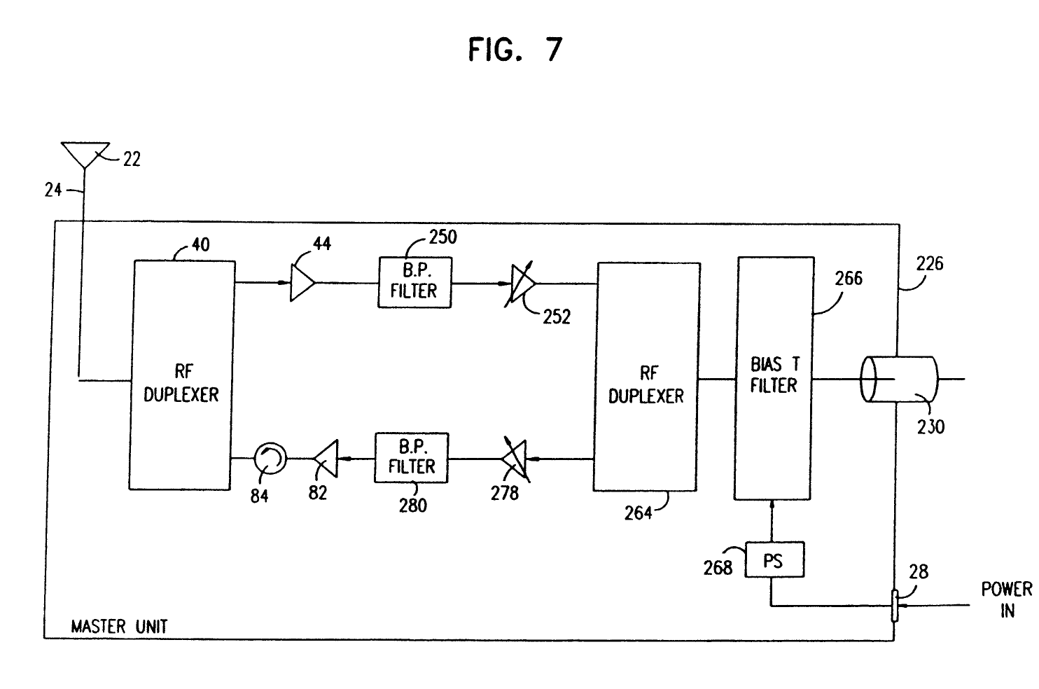

FIG. 7 is a schematic block diagram of master unit 226, according to a preferred embodiment of the present invention. Master unit 226 receives an RF master signal from antenna 22 via conductor 24, and the signal is transferred via RF duplexer 40 to low-noise-amplifier 44, which operates substantially as described above for master unit 26. The output of amplifier 44 is transferred to an RF band-pass filter 250, most preferably a surface acoustic wave (SAW) filter, which passes frequencies transmitted by transmitter 23 and rejects other frequencies. The amplified master signal passed by filter 250 is input to a variable gain RF amplifier 252, whose gain is preferably set when master unit 226 is initially installed. The gain setting of amplifier 252, and of other variable gain amplifiers in system 220, is described in more detail below. The output of amplifier 252 is input to an RF duplexer 264, which routes the RF signal from amplifier 252 to a bias-T filter 266.

Master unit 226 preferably comprises a power supply 268 which receives input power via a connector 228. The input power is preferably standard AC line power, or alternatively another standard power source such as a battery. Power supply 268 supplies DC power to operate unit 226, and also supplies DC power to filter 266, which acts as a port and wherein the DC power and received RF signal are combined and transferred to a coaxial RF cable 230. Cable 230 is preferably a doubly-shielded coaxial cable, or alternatively is another standard form of coaxial cable capable of transmitting RF signals with low loss. Cable 230 transfers the combined DC power and amplified RF master signal to slave unit 232.

Filter 266 also receives an amplified RF slave signal from slave unit 232, the generation of which signal is described below, and transfers the signal to duplexer 264. Duplexer 264 routes the slave signal to a variable gain RF amplifier 278, whose gain is preferably set at installation of unit 226. Amplifier 278 transfers its output to a band-pass filter 280, preferably a SAW filter which passes frequencies transmitted by transmitter 25 and rejects other frequencies. The output of filter 280 is transferred to power amplifier 82, isolator 84 and duplexer 40, which function substantially as described above for master unit 26. Duplexer 40 transfers the amplified RF slave signal via conductor 24 to antenna 22, which radiates the signal.

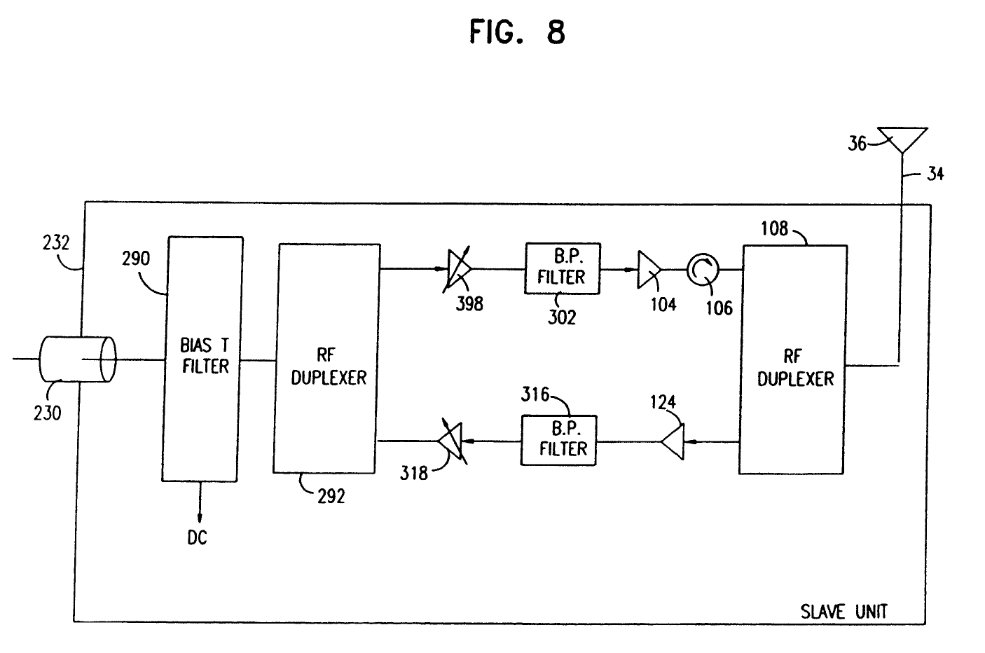

FIG. 8 is a schematic block diagram of slave unit 232, according to a preferred embodiment of the present invention. Slave unit 232 comprises a bias-T filter 290 which acts as a port and which is coupled to cable 230. Filter 290 receives the combined DC power and amplified RF master signal from cable 230, and separates the DC level to power unit 232. The RF master signal is transferred to an RF duplexer 292, which routes the signal to a variable gain amplifier 398 whose gain is preferably set when slave unit 232 is installed. The output of amplifier 398 is input to a band-pass filter 302, preferably a SAW filter which passes frequencies transmitted by transmitter 23 and rejects other frequencies. The output of filter 302 is transferred via power amplifier 104, isolator 106, RF duplexer 108 and conductor 34 to antenna 36, substantially as described above for slave unit 32, and antenna 36 radiates the amplified RF master signal.

Slave unit 232 also receives, substantially as described above for slave unit 32, an RF slave signal from transmitter 25 via antenna 36, conductor 34, duplexer 108, and low-noise amplifier 124. The amplified RF slave signal, output from amplifier 124, is fed to a band-pass filter 316, which is preferably a SAW filter that passes frequencies transmitted by transmitter 25 and rejects other frequencies. Filter 316 inputs the filtered signal to a variable gain amplifier 318, whose gain is preferably set when slave unit 232 is installed, and the amplified slave RF signal is routed by RF duplexer 292 to filter 290, which transfers the signal to cable 230.

Most preferably, the gains of amplifiers 252, 278, 318, and 398 are adjusted so that an overall gain for the master RF signal, and for the slave RF signal, are each of the order of 90 dB, the specific overall gains being set according to signal levels from transmitters 23 and 25. The gains of the amplifiers are preferably set so as to minimize losses in and radiation from cable 230, and so that the gains in the master unit and the slave unit are approximately equal.

The preferred embodiments described above comprise master and slave units separated by a coaxial cable. It will be appreciated that the separation of the units and their respective antennas facilitate the placement and orientation of the antennas so that signals may be transmitted by each antenna substantially without being received by the other antenna.

It will further be appreciated that the preferred embodiments described above are cited by way of example, and the full scope of the invention is limited only by the claims.

1. A radio-frequency (RF) repeater, comprising:
a) a master antenna, positioned to receive an RF master signal;
b) a master unit, comprising:
i) a master RF port, coupled to receive the RF master signal from the master antenna;
ii) a local oscillator, which generates a master local oscillator signal at a local oscillation frequency; and
iii) a master mixer which mixes the RF master signal and the master local oscillator signal to generate an intermediate frequency (IF) signal;
c) a cable which is coupled to the master unit so as to receive therefrom the IF signal and a reference signal at a reference frequency, derived from the local oscillator signal;
d) a slave antenna, positioned in a common environment with the master antenna; and
e) a slave unit, coupled to receive the IF signal and the reference signal from the cable, the slave unit comprising:
i) a slave mixer which mixes the IF signal and a slave local oscillator signal at the local oscillation frequency, derived from the reference signal, so as to recover the received RF master signal; and
ii) a slave RF port, which is coupled to convey the recovered RF master signal to the slave antenna for transmission thereby.

2. A repeater according to claim 1, wherein the master port is a two-way port, and wherein the slave RF port is a two-way port through which the slave unit receives an RF slave signal from the slave antenna and downconverts the RF slave signal by mixing it with the slave local oscillator signal to produce a slave IF signal which is conveyed by the cable to the master unit, wherein the slave RF signal is recovered and is conveyed by the master port to the master antenna for transmission thereby.

3. A repeater according to claim 1, wherein the reference frequency is substantially less than the local oscillator frequency.

4. A repeater according to claim 3, wherein the master unit comprises a frequency divider which divides the local oscillation frequency by an integer to derive the reference frequency, and wherein the slave unit comprises a frequency multiplier which multiplies the reference frequency by the integer to regenerate the local oscillation frequency.

5. A repeater according to claim 1, wherein the master unit comprises a DC power supply which generates a DC level that is conveyed by the cable to power the slave unit.

6. A repeater according to claim 1, and comprising a controller in one of the slave or master units which controls the operation of both units.

7. A repeater according to claim 6, and comprising a remote control unit which transfers control signals between the controller and an operator of the repeater.

8. A repeater according to claim 6, wherein the controller generates modulated control signals which are conveyed by the cable between the master and the slave units.

9. A repeater according to claim 1, wherein the repeater operates in a communications network at frequencies in the range 450 MHz to 30 GHz.

10. A repeater according to claim 9, wherein the repeater operates in a cellular communications network at frequencies in the range 800 MHz to 1900 MHz.

11. A repeater according to claim 1, wherein the frequency of the IF signal is substantially less than the frequency of the RF signal.

12. A repeater according to claim 1, wherein the frequency of the IF signal is substantially less than the local oscillation frequency.

13. A repeater according to claim 1, wherein the IF signal corresponds to one or more predetermined channels of a multiple access communications network.

14. A radio-frequency (RF) repeater, comprising:
a) a master unit, comprising:
i) a master RF port, coupled to receive an RF signal from a master antenna;
ii) a local oscillator, which generates a master local oscillator signal at a local oscillation frequency; and
iii) a master mixer which mixes the RF signal and the master local oscillator signal to generate an intermediate frequency (IF) signal;
b) a cable which is coupled to the master unit so as to receive therefrom the IF signal and a reference signal at a reference frequency substantially less than the local oscillation frequency, which reference signal is derived from the local oscillator signal; and
c) a slave unit, coupled to receive the IF signal and the reference signal from the cable, the slave unit comprising:
i) a slave mixer which mixes the IF signal and a slave local oscillator signal at the local oscillation frequency, derived from the reference signal, so as to recover the received RF signal; and
ii) a slave RF port, which is coupled to convey the recovered RF signal to a slave antenna.

15. A repeater according to claim 14, wherein the master port is a two-way port, and wherein the slave port is a two-way port through which the slave unit receives an RF slave signal from the slave antenna and downconverts the RF slave signal by mixing it with the slave local oscillator signal to produce a slave IF signal which is conveyed by the cable to the master unit, wherein the slave RF signal is recovered and is conveyed by the master port to the master antenna for transmission thereby.

16. A repeater according to claim 14, wherein the master unit comprises a frequency divider which divides the local oscillation frequency by an integer to derive the reference frequency, and wherein the slave unit comprises a frequency multiplier which multiplies the reference frequency by the integer to regenerate the local oscillation frequency.

17. A repeater according to claim 14, wherein the master unit comprises a DC power supply which generates a DC level which is conveyed by the cable to power the slave unit.

18. A repeater according to claim 14, and comprising a controller in one of the slave or master units which controls the operation of both units.

19. A repeater according to claim 14, wherein the IF signal corresponds to one or more predetermined channels of a multiple access communications network.

20. A method for repeating a radio-frequency (RF) signal, comprising:
a) receiving the RF signal from a first antenna at a first location;
b) generating at the first location a first local oscillator signal having a local oscillation frequency;
c) mixing the RF signal with the first local oscillator signal at the first location to produce an intermediate frequency (IF) signal;
d) deriving a reference signal having a reference frequency from the first local oscillator signal at the first location;
e) transferring the IF and reference signals over a cable to a second location in a common environment with the first location;
f) processing the reference signal at the second location to reconstruct the local oscillator signal at the local oscillation frequency;
g) mixing the IF signal and the local oscillator signal at the second location to recover the RF signal; and
h) transferring the recovered RF signal to a second antenna at the second location for transmission of the signal thereby.
